(19) United States
(12) Patent Application Publication
(10) Pub. No.: US 2008/0190301 A1
(43) Pub. Date: Aug. 14, 2008

(54) STIR COOKER

(76) Inventor: ZHENG PENG, Ypsilanti, MI (US)

Correspondence Address: ZHAOXIA XU, 4694 SYCAMORE DR., YPSILANTI, MI, 48197, US

(21) Appl. No.: 11/674,122

(22) Filed: Feb. 12, 2007

(51) Int. Cl. A47J 27/00

(52) U.S. Cl. 99/348

(57) ABSTRACT

A stir cooker (100). Stir cooker (100) comprises a container (102) having an open top and a sidewall for holding food, a lid (104) for closing the open top of container (102), a stirrer (114) installed inside container (102) for stirring food, a co-rotation prevention member (118) installed inside container (102) on the sidewall for preventing food pieces from co-rotating with stirrer (114), as stirrer (114) rotates, a heating tube (116) fixedly installed on the bottom of container (102) for heating food, a base support (112) disposed underneath container (102) for supporting container (102), a support member (110) installed on the bottom of container (102) for adapting container (102) to stand in position on base support (112), and a motor (124) installed inside base support (112) and coupled with stirrer (114) for driving stirrer (114) to stir food.

### TECHNICAL FIELD AND INDUSTRIAL APPLICABILITY OF THE INVENTION

This invention generally relates to cooking apparatuses or equipment. More specifically, this invention relates to stir cookers.

### BACKGROUND OF THE INVENTION

Traditional cookers have a container sitting on a heater that has a thermal diffusion plate and a heating tube installed on the bottom of the diffusion plate and a handle for use of handling the container. When cooking, people have to stir food to facilitate heat transfer and uniform heating. Such cooking techniques include stir-frying, sautéing, braising, simmering, etc.; which require skill and labor.

In order to automate cooking processes, a stirring mechanism, which is installed inside the container for stirring food, has been proposed to facilitate heat transfer and uniform heating. The stirring mechanism is the key for cooking automation for fast and quality cooking and a “technological breakthrough” over traditional ways of cooking. Immediate advantages include: facilitated heat transfer and more uniform heating to save time and energy; reduced labor and skill requirements to consumers; closed lid on pan/pot to avoid cooking fumes and splashing for home environment protection, at the same time, save energy.

U.S. Pat. No. 6,845,707, issued to Xu, et al., on Jan. 25, 2006, teaches regarding an automatic cooking apparatus having a stirrer installed inside an inner pan for automated stirring and cooking.

U.S. Pat. No. 4,649,810, issued to Wong, on Mar. 17, 1987, illustrates an automatic cooking apparatus having a compartmentalized carousel for various ingredients of a particular dish to be loaded and a stirring blade generally conforming to the shape of the bottom of a cooking vessel. As the blade revolves around a vertical axis, it causes the foods to spread and to roll over the top of the blade.

However, prior art products have a full housing and a full heater in designs, resulting in being too bulky for kitchens and too expensive to manufacture. Market testing has shown that consumers desire a stir cooker of high performance, at the same time, compact and simple enough to be less bulky to save kitchen space and to be less expensive to manufacture.

Therefore, it remains desirable to provide a stir cooker that is innovative in design, such that it is less bulky to save kitchen space and less expensive to manufacture.

### BRIEF SUMMARY OF THE INVENTION

Accordingly, the present invention is a stir cooker. This stir cooker comprises a container having an open top and a sidewall for holding food, a lid for closing up the open top of the container, a support member fixedly engaged with the lower portion of the container and extended downward to a predetermined distance for adapting the container to sit on a base support or a horizontal counter top, a stirrer installed inside the container for stirring food, a heating tube installed on the bottom of the container for heating food, a co-rotation prevention member installed on the sidewall of the container for preventing food co-rotation with the stirrer, as the stirrer rotates, and a motor installed inside the base support and removably coupled with the stirrer for driving the stirrer.

Accordingly, the followings are some of the objects, features, and advantages of the present invention.

It is an object of the present invention to provide a stir cooker that is simple to use, less bulky to save kitchen space, and less expensive to manufacture.

It is a feature of the present invention that this stir cooker includes a support member for supporting the container. The upper end of the support member is fixedly engaged with the periphery of the bottom portion of the container and the lower end of the support member extends downward to a predetermined distance for adapting the container to stand on a base support or on a horizontal surface.

It is another feature of the present invention that the heating tube is fixedly installed on the bottom of the container to save some cost associated with a heater having a thermal diffusion plate, which requires significant amount of material and space. By directly installing the heating tube on the bottom of the container heating efficiency is also significantly enhanced.

It is a further more feature of the present invention that a thermostat is removably engaged with the bottom of the container for detecting and limiting the temperature and controlling the heating tube.

It is a still further more feature of the present invention that the container is not enclosed inside a housing, such that some cost and space associated with a full housing is saved, compared with prior art products.

It is an advantage of the present invention that the stir cooker is highly compact to save space and material cost.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a cross-sectional view of an embodiment of the present invention, a stir cooker 100.

FIG. 2 illustrates a bottom view of container 102.

FIG. 3 illustrates a top view of base support 112.

FIG. 4 illustrates an exploded cross-sectional view of seal device 130 and coupling device 132.

FIG. 5 illustrates another cross-sectional view of stir cooker 100.

FIG. 6 illustrates a cross-sectional view of another embodiment of the present invention, a stir cooker 200.

FIG. 7 illustrates a side view of coupling device 208 for stir cooker 200.

FIG. 8 illustrates a top view of coupling device 208 for stir cooker 200.

### DETAILED DESCRIPTION OF THE INVENTION

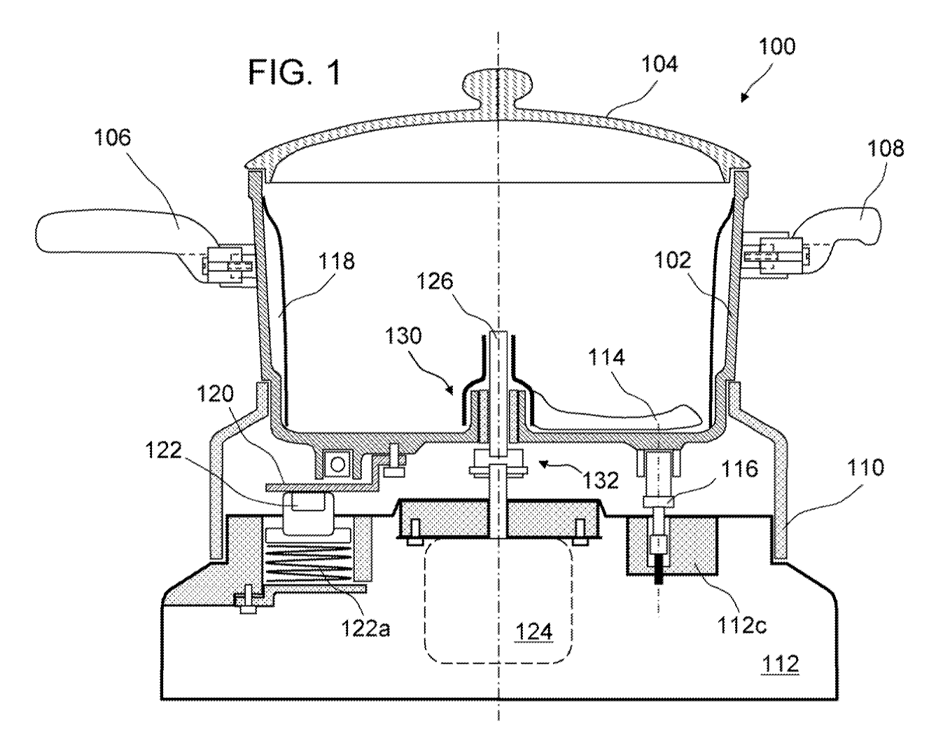

Reference is made to FIG. 1, which illustrates a cross-sectional view of an embodiment of the present invention, a stir cooker 100.

A container 102, having an open top, a sidewall, and a central aperture on the bottom, is provided for holding food. The sidewall of container 102 is slightly tapered with a larger diameter on the top and a smaller diameter on the bottom. Container 102 is, preferably, coated with a non-stick material.

A lid 104 is provided for closing up the open top of container 102. Lid 104 is, preferably, made of a transparent material.

A grasp handle 106 and a lift handle 108 are fixedly installed on the upper portion of the sidewall of container 102 for use of handling container 102.

A support member 110, having a generally tapered hollow cylindrical configuration, is provided for supporting container 102. The upper end of support member 110 is fixedly engaged with the periphery of the bottom portion of container 102 and the lower end of support member 110 is extended downward to a predetermined distance such that container 102 is adapted to stand on a base support 112 or on a horizontal countertop. Support member 110 is also provided for enclosing the space underneath the bottom of container 102 into a protected space. Some windows or slots may be opened on support member 110 for venting heat etc.

A stirrer 114, removably installed inside container 102, is provided for stirring food. The clearance between the lower edge of stirrer 114 and the bottom of container 102 is minimized for better stirring performance. The profile of stirrer 114 is optimized for minimizing stirring resistance, such that less motor power is required to drive stirrer 114, which saves some cost on motors.

An electrical heating tube 116, having a generally circular configuration, is provided for heating food disposed inside container 102. Heating tube 116 is fixedly installed on the outside surface of the bottom of container 102, inserted into a groove formed on the bottom of container 102, and disposed close to the periphery with a predetermined distance. The two electrical terminals of heating tube 116 extend downward to a predetermined distance and are adapted to removably engage with an electrical power supply, as container 102 is installed in position on base support 112. There are significant advantages of installing heating tube 116 directly on the bottom of container 102. These advantages include saving a significant amount of material for building a full heater that has a thermal diffusion plate, resulting in space and cost saving and higher heat transfer efficiency due to the direct attachment of heating tube 116 on the bottom of container 102, etc.

A plurality of co-rotation prevention members 118 is integrally constructed inside container 102, on the sidewall, for preventing food pieces from co-rotating with stirrer 114, as stirrer 114 rotates. Members 118 include a rib-shaped elongated member that extends generally vertical along the sidewall of container 102. The upper ends of members 118 extend substantially to the upper portion of container 102. Members 118 are preferably disposed substantially dose to handles 106 or 108 such that members 118 would not obstruct food unloading. Members 118 extend inward to a predetermined distance, away from the sidewall of container 102. The predetermined distance is determined based on the size of container 102. Proper clearance between members 118 and stirrer 114 should be maintained. When food co-rotates with stirrer 114 and runs against members 118, as stirrer 114 rotates, food pieces at a higher level close to members 118 would be stopped and tumbled down due to gravity, resulting in better mixing or stirring of food, thereby facilitating heat transfer to and uniform heating of food.

A thermo plate 120, made of a material of high thermal conductivity, is fixedly installed on the bottom of container 102, at a location substantially dose to heating tube 116, for removably engaging a thermostat 122. Thermostat 122 is installed on base support 112 and engaged with thermo plate 120 for detecting the temperature as container 102 is installed in position on base support 112. Such temperature is used to control the electrical power to heating tube 116. The upper end of thermostat 122 protrudes upward above the upper surface of base support 112 with pre-loading, e.g., via a spring 122a. Thermostat 122 can be a digital sensor, such as a NTC or PTC, or an adjustable thermostat, or simply a temperature switch, as known to those skilled in the art.

Base Support 112, disposed underneath container 102, is provided for supporting container 102. The upper portion of base support 112 is removably engaged with the inner periphery of the lower portion of support member 110. As container 102 is installed in position on base support 112, thermostat 122 is engaged with thermo plate 120, or directly with the bottom of container 102, and the electrical terminals of heating tube 116 are removably connected with an electrical port 112c on base support 112.

A motor 124 is installed inside base support 112 for providing rotation power to stirrer 114. Motor 124 is removably coupled with a drive shaft 126, as container 102 is installed in position. Drive shaft 126 is threaded through the central aperture on the bottom of container 102. The upper end of shaft 126 is engaged with stirrer 114 and the lower end of shaft 126 is coupled with motor 124 through a coupling device 132. A seat device 130 is provided for sealing off the interface between shaft 126 and the bottom of container 102.

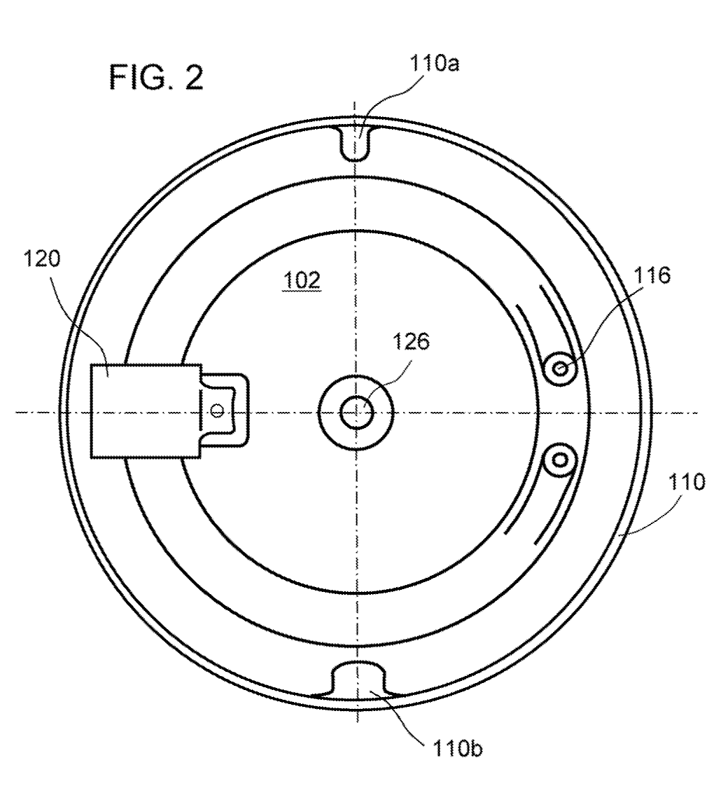

FIG. 2 illustrates a bottom view of container 102 to depict the general layout of various components disposed on the bottom of container 102. Two position guides, generally designated as 111a and 110b, protrude inward a predetermined distance from the inner surface of support member 110 for guiding container 102 in position on base support 112.

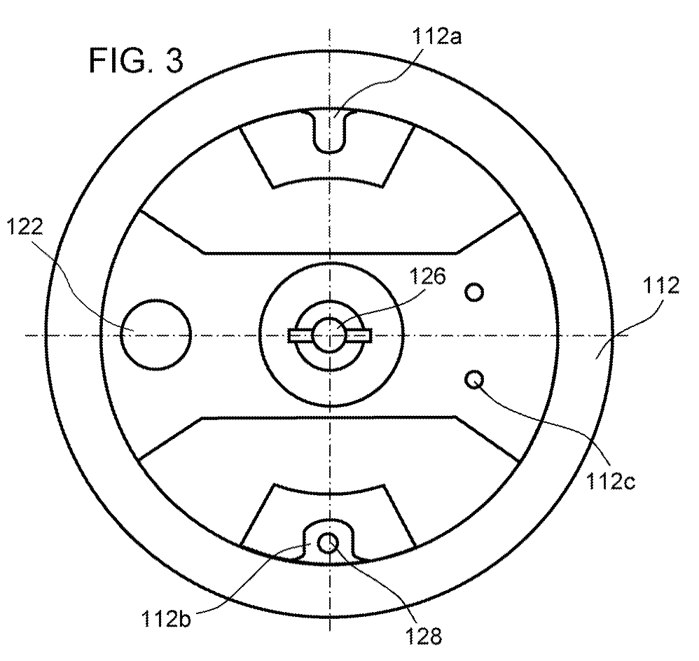

FIG. 3 illustrates a top view of base support 112 to depict the general layout of various components disposed on the top of base support 112. Two base guides, generally designated as 112a and 112b, are provided for removably receiving position guides 110a and 110b, respectively. Electrical port 112c is provided on top of base support 112 for removably receiving the electrical terminals from heating tube 116, such that electrical power from base support 112 is provided to heating tube 116, as container 102 is installed in position on base support 112. An in-position detector 128 is installed on base support 112 for detecting whether container 102 is properly installed or not. Detector 128 is disposed at the bottom of base guide 112b. The upper end of detector 128 protrudes a predetermined distance above the bottom of guide 112b, such that when container 102 is installed in position on base support 112, the lower end of position guide 110b would press with a force on detector 128 to confirm that container 102 is well positioned.

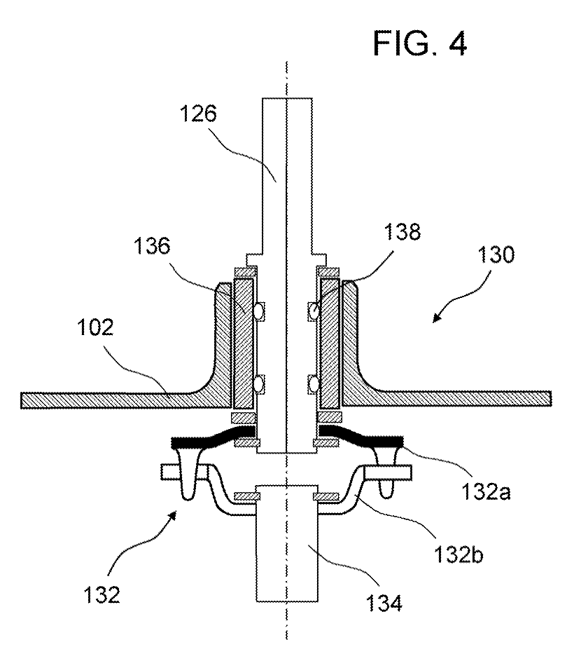

FIG. 4 illustrates an exploded cross-sectional view of seal device 130 and coupling device 132. Seal device 130 comprises a bushing member 136 and a packing member 138. Coupling device 132 includes an upper coupling element 132a and lower coupling element 132b.

Drive shaft 126 is threaded through the central aperture on the bottom of container 102. The upper end of shaft 126 is engaged with stirrer 114 and the lower end of shaft 126 extends downward through the central aperture on the bottom of container 102, leading to coupling device 132. Coupling element 132a is engaged with the lower end of shaft 126. Coupling element 132b is engaged with a motor shaft 134.

Bushing 136 is co-axial to shaft 126 and is fixedly and sealingly engaged with the bottom of container 102. Packing 138 is inserted inside a groove cut around shaft 126. A plurality of packing 138 can be provided for more reliable sealing, as known to those skilled in the art. When inserted into bushing 136 together with shaft 126, packing 138 is compressed and squeezed against shaft 126 and bushing 136 to seal off the interface thereof. Bushing 136 extends upward to a predetermined height above the bottom of container 102, such that the upper end of bushing 136 and packing 138 are disposed above the bottom of container 102 and such that the requirement on seal device 130 is significantly reduced. The tolerance between bushing 136 and shaft 126 is minimized for ideal sealing performance, but, at the same time, shaft 126 should be able to rotate with minimal friction resistance, which requires high precision of the fitting surfaces thereof.

Materials for packing 138 are extremely important when selecting the proper packing for an application. Basic requirements include heat resistance, wearing resistance, elasticity, etc.

Seal device 130 can, alternatively, take many other forms, such as bushing, labyrinth, packing, or combinations of multiple forms for ideal performance, as known to those skilled in the art and suggested by this invention disclosure.

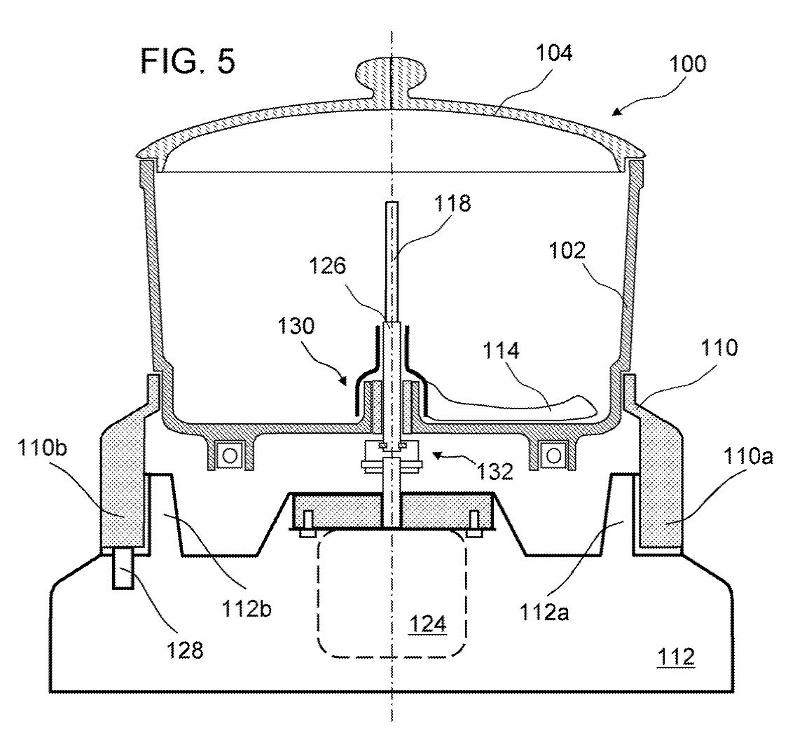

FIG. 5 illustrates another cross-sectional view of stir cooker 100 to better describe how container 102 is installed on base support 112. Position guides 110a and 110b are inserted into base guides 112a and 112b, respectively, such that container 102 is removably locked in position on base support 112.

Accordingly, as container 102 is properly installed in position on base support 112, thermostat 122 is engaged with thermo plate 120, or directly with the bottom of container 102, the electrical terminals of heating tube 116 are connected with electrical port 112c, motor 124 is coupled with shaft 126, and detector 128 is depressed to confirm that container 102 is well in position. Stir cooker 100 is, now, ready for cooking.

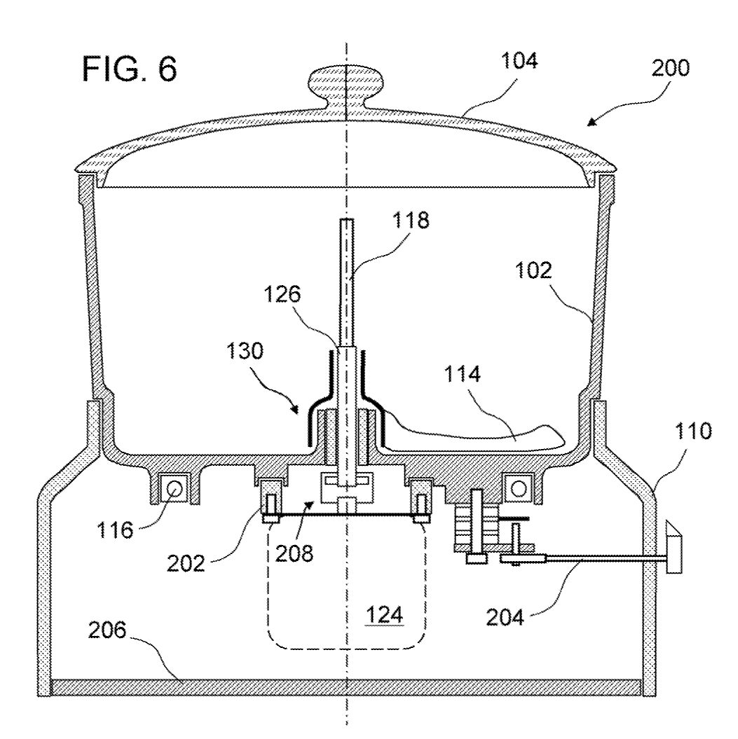

FIG. 6 illustrates a cross-sectional view of another embodiment of the present invention, a stir cooker 200. Some components or devices of stir cooker 200 are similar to those of stir cooker 100. Similarity is in the sense of both functionality and configuration. Therefore, similar components or devices are denoted with similar reference numbers to avoid repetitive explanations. Stir cooker 200 is a further simplified version of stir cooker 100.

Motor 124 is directly installed on the bottom of container 102. A plurality of insulation block 202 is provided in between motor 124 and the bottom of container 102 for shielding motor 124 away from heat transferred from the bottom of container 102. An adjustable thermostat 204, installed directly on the bottom of container 102, is provided for controlling the temperature of heating tube 116. A bottom cap 206 is provided for closing the bottom opening of support member 110.

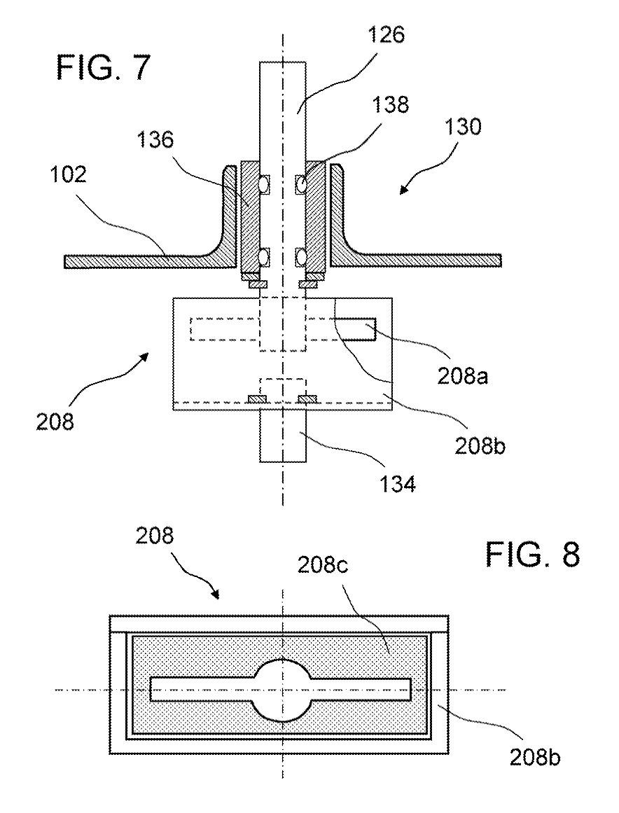

Reference is made to FIG. 7, which illustrates a side view of coupling device 208. Coupling device 208 is provided for coupling motor 124 and drive shaft 126. Coupling device 208 includes an upper coupling element 208a, which is engaged with drive shaft 126, and a lower coupling element 208b, which is engaged with motor shaft 134. An insulation insert 208c, as more clearly shown in FIG. 8, which illustrates a top view of coupling device 208, is provided in between coupling elements 208a and 208h, such that heat transferred from drive shaft 126 is prevented from passing through to motor 124, and whereby motor 124 is not overheated with the heat transferred from the bottom of container 102.

Accordingly, readers will see that this stir cooker of the present invention is highly compact to save kitchen space and manufacturing cost. The container is removable from the base support, such that it is convenient for cleaning after use and dishwasher safe.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A stir cooker, said stir cooker comprising:
a container having an open top and a sidewall for holding food;
a lid for closing up the open top of said container;
stirring means installed inside said container for stirring food;
heating means for heating food disposed inside said container;
wherein said heating means is installed on the bottom of said container;
a motor installed on the bottom of said container for driving said stirring means;
wherein said motor is coupled with a drive shaft and said drive shaft is coupled with said stirring means;
a support member having two ends for supporting said container; and
wherein the upper end of said support member is fixedly engaged with the periphery of the lower portion of said container and the lower end of said support member extends downward to a predetermined distance, such that said stir cooker is adapted to stand on a horizontal surface.

2. A stir cooker as defined in claim 1, wherein said heating means includes a heating tube of a circular configuration, said heating tube is fixedly installed inside a groove formed on the bottom of said container, and said heating tube is disposed close to the periphery of the bottom of said container with a predetermined distance.

3. A stir cooker as defined in claim 1, wherein said drive shaft is threaded through a central aperture opened on the bottom of said container and wherein said container includes a seal device for sealing off the interface between said drive shaft and said central aperture on the bottom of said container.

4. A stir cooker as defined in claim 3, wherein said seal device includes a bushing member fixedly and sealingly engaged with said central aperture on the bottom of said container, said drive shaft is threaded through said bushing member, and at least one packing member is adapted to be squeezed against said drive shaft and said bushing member for sealing off the interface thereof.

5. A stir cooker as defined in claim 1, wherein said container includes at least one co-rotation prevention member installed on the sidewall of said container for preventing food from co-rotation with said stirring means, as said stirring means rotates, and wherein said at least one co-rotation prevention member is extended generally vertical along the sidewall of said container, is generally rib-shaped, is extended from the lower portion of said container upward to the upper portion of said container, and is extended inward from the sidewall of said container to a predetermined distance, away from the sidewall of said container.

6. A stir cooker as defined in claim 5, wherein said at least one co-rotation prevention member is disposed substantially close to a grasp handle or a lift handle, such that said at least one co-rotation prevention member does not obstruct food unloading.

7. A stir cooker as defined in claim 1, said stir cooker further including a thermostat installed on the bottom of said container for detecting and limiting the temperature of said heating means, such that said heating means and the neighboring components are not overheated and said stir cooker is adapted for multiple applications.

8. A stir cooker as defined in claim 1, wherein said motor is coupled with said drive shaft through a coupling device, and said coupling device includes a insulation block, such that heat transferred from said drive shaft is prevented from passing through to said motor, and whereby said motor is not overheated with the heat transferred from the bottom of said container.

9. A stir cooker as defined in claim 1, wherein said motor is fixedly engaged with a insulation member, said insulation member is fixedly installed on the bottom of said container, such that heat transferred from the bottom of said container is prevented from passing through to said motor, and whereby said motor is not overheated with the heat transferred from the bottom of said container.

10. A stir cooker, said stir cooker comprising:
a container having an open top and a sidewall for holding food;
a lid for closing up the open top of said container;
stirring means installed inside said container for stirring food;
heating means for heating food disposed inside said container;
wherein said heating means is installed on the bottom of said container;
a base support disposed underneath said container for supporting said container;
a motor installed inside said base support for driving said stirring means;
wherein said motor is removably coupled with a drive shaft and said drive shaft is coupled with said stirring means;
a support member having two ends for supporting said container,
wherein the upper end of said support member is fixedly engaged with the periphery of the lower portion of said container and the lower end of said support member extends downward to a predetermined distance, such that said container is adapted to stand on said base support;
wherein said motor is coupled with said stirring means as said container is disposed in position on said base support;
wherein said heating means is connected with an electrical port on said base support as said container is disposed in position on said base support;
wherein said container together with said support member is removable from said base support; and
whereby said container is convenient for cleaning after use and dishwasher safe.

11. A stir cooker as defined in claim 10, wherein said heating means includes a heating tube of a circular configuration, said heating tube is fixedly installed inside a groove formed on the bottom of said container, and said heating tube is disposed close to the periphery of the bottom of said container with a predetermined distance.

12. A stir cooker as defined in claim 10, wherein said drive shaft is threaded through a central aperture opened on the bottom of said container and wherein said container includes a seal device for sealing off the interface between said drive shaft and said central aperture on the bottom of said container.

13. A stir cooker as defined in claim 12, wherein said seal device includes a bushing member fixedly and sealingly engaged with said central aperture on the bottom of said container, said drive shaft is threaded through said bushing member, and at least one packing member is adapted to be squeezed against said drive shaft and said bushing member for sealing off the interface thereof.

14. A stir cooker as defined in claim 10, wherein said container includes at least one co-rotation prevention member installed on the sidewall of said container for preventing food from co-rotation with said stirring means, as said stirring means rotates, and wherein said at least one co-rotation prevention member is extended generally vertical along the sidewall of said container, is generally rib-shaped, is extended from the lower portion of said container upward to the upper portion of said container, and is extended inward from the sidewall of said container to a predetermined distance, away from the sidewall of said container.

15. A stir cooker as defined in claim 14, wherein said at least one co-rotation prevention member is disposed substantially close to a grasp handle or a lift handle, such that said at least one co-rotation prevention member does not obstruct food unloading.

16. A stir cooker as defined in claim 10, said stir cooker further including a thermostat installed inside said base support for detecting and limiting the temperature of said heating means, such that said heating means and the neighboring components are not overheated and said stir cooker is adapted for multiple applications.

17. A stir cooker as defined in claim 16, wherein said thermostat is preloaded with a spring member, the upper end of said thermostat protrudes upward above the upper surface of said base support, and when said container is disposed in position on said base support said thermostat is adapted to be engaged with the bottom of said container.

18. A stir cooker as defined in claim 16, wherein said thermostat is preloaded with a spring member, a thermo plate is fixedly installed on the bottom of said container at a location substantially close to said heating means, the upper end of said thermostat protrudes upward above the upper surface of said base support and when said container is disposed in position on said base support said thermostat is adapted to be engaged with said thermo plate.

19. A stir cooker as defined in claim 10, wherein said support member includes at least one position guide for guiding said container in position on said base support, said base support includes at least one base guide for removably receiving said at least one position guide from said support member, such that said container is guided in position on said base support.

20. A stir cooker as defined in claim 10, wherein said support member has a generally tapered hollow cylindrical configuration, the upper end of said support member is routed over the lower portion of said container and is fixedly engaged thereof, the lower end of said support member is routed over the upper portion of said base support and is removably engaged thereof, the upper portion of said base support removably receives the lower end of said support member.
